(19) United States
(12) Patent Application Publication
(10) Pub. No.: US 2001/0011068 A1
(43) Pub. Date: Aug. 2, 2001

(54) Stain and soil removal release in the laundering of textile fabrics

(76) Inventors: Nigel Peter Bird, Bebington, Wirral (GB); Abigail Marr, Bebington, Wirral (GB); John William Yorke, Bebington, Wirral (GB)

Correspondence Address: UNILEVER, PATENT DEPARTMENT, 45 RIVER ROAD, EDGEWATER, NJ, 07020, US

(21) Appl. No.: 09/737,605

(22) Filed: Dec. 15, 2000

(30) Foreign Application Priority Data
Dec. 16, 1999 (GB) 9929837.4

(51) Int. Cl. C11D 17/00; C11D 17/06; C11D 3/02; C11D 7/02; D06M 10/00

(52) U.S. Cl. 510/507; 510/447; 8/115.51

(57) ABSTRACT

Use of a light colored crystalline clay mineral as a component of a composition for laundering of textile fabrics to assist removal of soil from the fabrics.

### FIELD OF THE INVENTION

The present invention relates to a novel use of clays in the laundering of textile fabrics.

### BACKGROUND OF THE INVENTION

In countries where textile fabrics are habitually washed by hand, even using premium laundry cleaning products, the degree of cleaning achieved is frequently disappointing.

The present inventors have now discovered that incorporation of clays in compositions for the laundering of textile fabrics can improve stain removal. Without being bound by any particular theory or explanation, the inventors have conjectured that by depositing on the fabric, the clays act as a sacrificial layer so that particulate soil preferentially binds to the clay layer instead of the fibres of the fabric, so that when the clay is removed during the subsequent next wash, the soil is thereby removed more easily.

It is well known to incorporate clays in products for the washing or the conditioning of the fabrics, as a fabric softener material. Known use of clays in household cleaning products are described, for example in EP-A-6 317 926, EP-A-0 181 508, WO-A-95/33038, WO-A-95/27037, U.S. Pat. No. 5,332,513, U.S. Pat. No. 5,017,296 and U.S. Pat. No. 4,861,510. However, the ability of the clay to assist soil and/or stain removal is new.

### DEFINITION OF THE INVENTION

The present invention now provides use of a light coloured crystalline clay mineral as a component of a composition for the laundering of textile fabrics to assist removal of soil from the fabrics.

### DETAILED DESCRIPTION OF THE INVENTION

The present invention uses a light coloured crystalline clay mineral as a component in a product for the washing and/or rinsing of textile fabrics.

The light coloured crystalline clay mineral is typically incorporated in a laundry wash composition and/or a laundry rinse composition, for application to the fabrics by dispersion or dissolution in a wash and/or rinse liquor, with which the fabrics are contacted, especially during washing and/or rinsing by hand. This is to allow deposition of the clay onto the fabrics.

### SURFACTANTS

In the case of a washing composition, the composition typically comprises one or more deterging synthetic non-soap surfactants, chosen from anionic, nonionic, cationic and zwitterionic surfactants and mixtures thereof, as will be well known to those skilled in the art. Soap may also be included in the composition. Many suitable surface-active compounds are available and are fully described in the literature, for example, in “Surface-Active Agents and Detergents”, Volumes I and II, by Schwartz, Perry and Berch.

The preferred detergent-active compounds that can be used are soaps and synthetic non-soap anionic and non-ionic compounds.

The compositions of the invention may for example contain linear alkylbenzene sulphonate, particularly linear alkylbenzene sulphonates having an alkyl chain length of C₈-C₁₅. It is preferred if the level of linear alkylbenzene sulphonate is from 0 wt % to 30 wt %, more preferably 1 wt % to 25 wt %, most preferably from 2 wt % to 15 wt %.

The compositions of the invention may contain other anionic surfactants in amounts additional to the percentages quoted above. Suitable anionic surfactants are well-known to those skilled in the art. Examples include primary and secondary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

The compositions of the invention may also contain non-ionic surfactant. Nonionic surfactants that may be used include the primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkylpolyglycosides, glycerol monoethers, and polyhydroxyamides (glucamide).

It is preferred if the level of non-ionic surfactant is from 0 wt % to 30 wt %, preferably from 1 wt % to 25 wt %, most preferably from 2 wt % to 15 wt %.

It is also possible to include certain mono-alkyl cationic surfactants which can be used in main-wash compositions for fabrics. Cationic surfactants that may be used include quaternary ammonium salts of the general formula R₁R₂R₃R₄N⁺X⁻ wherein the R groups are long or short hydrocarbon chains, typically alkyl, hydroxyalkyl or ethoxylated alkyl groups, and X is a counter-ion (for example, compounds in which R₁ is a C₈₋C₂₂ alkyl group, preferably a C₈-C₁₀ or C₁₂-C₁₄ alkyl group, R₂ is a methyl group, and R₃ and R₄, which may be the same or different, are methyl or hydroxyethyl groups); and cationic esters (for example, choline esters).

The choice of surface-active compound (surfactant), and the amount present, will depend on the intended use of the detergent composition. In fabric washing compositions, different surfactant systems may be chosen, as is well known to the skilled formulator, for handwashing products and for products intended for use in different types of washing machine.

The total amount of surfactant present will also depend on the intended end use and may be as high as 60 wt %, for example, in a composition for washing fabrics by hand. In compositions for machine washing of fabrics, an amount of from 5 to 40 wt % is generally appropriate. Typically the compositions will comprise at least 2 wt % surfactant e.g. 2-60%, preferably 15-40% most preferably 25-35%.

Detergent compositions suitable for use in most automatic fabric washing machines generally contain anionic non-soap surfactant, or non-ionic surfactant, or combinations of the two in any suitable ratio, optionally together with soap.

In the case of rinse products, one or more cationic fabric softener surfactant may be included.

### BUILDERS

The compositions for use according to the present invention may also contain one or more detergency builders.

The total amount of detergency builder in the compositions will typically range from 5 to 80 wt %, preferably from 10 to 60 wt %.

Inorganic builders that may be present include sodium carbonate, if desired in combination with a crystallisation seed for calcium carbonate, as disclosed in GB 1 437 950 (Unilever); crystalline and amorphous aluminosilicates, for example, zeolites as disclosed in GB 1 473 201 (Henkel), amorphous aluminosilicates as disclosed in GB 1 473 202 (Henkel) and mixed crystalline/amorphous aluminosilicates as disclosed in GB 1 470 250 (Procter & Gamble); and layered silicates as disclosed in EP 164 514B (Hoechst). Inorganic phosphate builders, for example, sodium orthophosphate, pyrophosphate and tripolyphosphate are also suitable for use with this invention.

The compositions of the invention preferably contain an alkali metal, preferably sodium, aluminosilicate builder. Sodium aluminosilicates may generally be incorporated in amounts of from 10 to 70% by weight (anhydrous basis), preferably from 25 to 50 wt %.

The alkali metal aluminosilicate may be either crystalline or amorphous or mixtures thereof, having the general formula: 0.8-1.5 Na₂O. Al₂O₃.0.8-6 SiO₂

These materials contain some bound water and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature. Suitable crystalline sodium aluminosilicate ion-exchange detergency builders are described, for example, in GB 1 429 143 (Procter & Gamble). The preferred sodium aluminosilicates of this type are the well-known commercially available zeolites A and X, and mixtures thereof.

The zeolite may be the commercially available zeolite 4A now widely used in laundry detergent powders. However, according to a preferred embodiment of the invention, the zeolite builder incorporated in the compositions of the invention is maximum aluminium zeolite P (zeolite MAP) as described and claimed in EP 384 070A (Unilever). Zeolite MAP is defined as an alkali metal aluminosilicate of the zeolite P type having a silicon to aluminium ratio not exceeding 1.33, preferably within the range of from 0.90 to 1.33, and more preferably within the range of from 0.90 to 1.20.

Especially preferred is zeolite MAP having a silicon to aluminium ratio not exceeding 1.07, more preferably about 1.00. The calcium binding capacity of zeolite MAP is generally at least 150 mg CaO per g of anhydrous material.

Optionally, organic builders such as citrates, suitable used in amounts of from 5 to 30 wt %, preferably from 10 to 5 wt % are used.

Builders, both inorganic and organic, are preferably present in alkali metal salt, especially sodium salt, form.

### THE CLAY

Compositions for use according to the present invention preferably contain from 2 to 98%, by weight of a light coloured crystalline clay material, (if used in the rinse) or preferably from 0.5% to 75% (if used in the wash), so as to be suitable for yielding at least 0.02 g/l, preferably at least 0.1 g/l of the clay in the wash and/or rinse liquor.

Preferably, the crystalline clay mineral is selected from one or more clays selected from bi-layer clays, e.g. china clay and halloysite, dioctahedral clays such as kaolinite, trioctahedral clays such as antigorite and amesite, smectite and hormite clays such as bentonite (montmorillonite), beidelite, nontronite, hectorite, attapulgite, pimelite, mica, muscovite and vermiculite clays, as well as pyrophyllite/talc, willemseite and minnesotaite clays.

The crystalline clay mineral must be light coloured. Preferably, it should have a reflectance of at least 60, more preferably at least 70, especially at least 80 at a wavelength of 460 nm. Preferably also, the number average particle diameter of the clay mineral particles should not exceed 2 μm, especially not exceeding 1 μm. This particle size diameter is that obtained measured by use of a Malvern Zetasizer™, using a dispersion of the clay mineral at 0.1 g/l in deionised water at 25° C., the clay being dispersed by vigorous hand agitation using a glass rod stirrer for 1 minute.

### OPTIONAL WATER-SOLUBLE SALT

Optionally, a water-soluble salt may also be included in the composition. This is believed to be beneficial because it promotes dispersion and assists flocculation of the clay particles in the rinse liquor and enables them to be uniformly dispersed in so deposit more uniformly on the fabric. This salt may already be incorporated in the composition for another purpose, e.g. as a detergency builder, such as an alkali metal tripolyphosphate or citrate.

Alternatively, any other water-soluble salt may be used but it is preferable to use a material which is widely available at low cost. Thus, one may use a soluble salt of a monovalent metal such as an alkali metal, for example sodium or potassium, e.g. as the chloride or sulphate. However, weight for weight, it is more effective to use a salt of divalent metal, or a water-soluble salt of a metal having a valency of three or more. However, the best balance of cheapness and effectiveness has been found to be obtained if the salt comprises magnesium ions. Magnesium chloride and magnesium sulphate are typical examples. The amount of salt used will depend on the valency of the metal but in the broadest concept, it will be used at a molar concentration of from 0.01 M to 1 M. In the case of a magnesium salt, the molar concentration will usually be from 0.001 M to 0.01 M in the rinse liquor. Thus, in the compositions according to the present invention, the amount of the water-soluble inorganic salt will be from 2 to 98 % by weight of the composition and in particular, for the magnesium chloride and/or sulphate, from 5 to 70 % by weight.

### OTHER OPTIONAL INGREDIENTS

Compositions which are used for washing will normally contain one or more surfactants, typically selected from one or more of anionic, nonionic, cationic and zwitterionic synthetic non-soap surfactants. They may additionally or alternatively contain soap. Wash compositions will usually also contain a detergency builder. Detergency builders which are water-soluble salts will then constitute all or part of the optional water-soluble salt component.

Compositions for use in the rinse at the minimum may contain only water. However, they may also contain one or more typical rinse conditioner ingredients such as cationic fabric softeners.

Compositions for use in accordance with the present invention may contain one or more additional benefit agents for subsequent dispersion and/or solution in the wash and/or rinse liquor. These may, for example, be selected from fluorescers, perfumes, starches, enzymes such as lipases, soil-release polymers, photobleaches and blueing agents. However, the composition, and therefore the rinse liquor, is preferably substantially free from organic surfactant.

### PRODUCT FORM

The compositions for use in accordance with the present invention may be provided in any suitable form to allow convenient dispersion/solution in the wash and/or rinse liquor by the consumer. Thus, for example, they may be provided as powders or granulated solids. They may also be provided in any of the forms of liquids, pastes, gels, bars or tablets.

The present invention will now be explained in more detail by way of the following non-limiting examples.

Prewash/Wash Protocol

| | |
|---|---|
| Wash Model | Tergotometer |
| Water Volume | 1 L |
| Water Hardness | 24° FH (2:1, Ca; Mg) |
| Water Temperature | Ambient (21° C.-24° C.) |
| Load Weight | 25 g |
| Liquor:Cloth | 40:1 |
| Formulation | As specified |
| Load | Rust Stains (cotton sheeting)/ballast |
| | (cotton sheeting) |
| Soak Time | 30 minutes |
| Wash Time | 15 minutes (Agitation) |
| Rinse Volume | 1 L (24° FH) |
| Number of Rinses | 2 |
| Agitation (rpm) | 90 |
| Drying Procedure | Rack dry |
| Repeats | 4 repeats, 9 replicates |

Stain Preparation/Application

Two pieces of iron were attached to an insulated electrical wire (with fold back clips) and then dipped into a saline solution, (care was taken not to allow the wire to come into contact with the water, as a black precipitation may result).

The solution was stirred until an orange precipitate of Fe³⁺ flocculated into large aggregates (if left for too long the solution may turn dark green). The solution was then poured into a second beaker and the iron oxide precipitate was allowed to settle to the bottom. Once settled out the excess water was decanted off, leaving the iron oxide slurry. This process was repeated until sufficient iron oxide had been produced.

A rust suspension consisting of one part rust, two parts water (1:2 iron oxide:water) was then made up and placed on a stirrer. The iron oxide suspension (0.3 ml) was then pipetted onto fabric (using a round template, diameter 4.5 cm) and brushed to create an even finish.

Once applied, the stains were allowed to age for 7 days in the dark at ambient temperature. R460* and DE reading were carried out on all stains prior to and after washing. (Typical before wash readings were 20 reflectance units at 460nm*).

Results

1. Detergency v Clay Level

Tests were carried-out using Composition A (given below) with added clay.

COMPOSITION A

| | PERCENTAGE |
|---|---|
| INGREDIENT | PRESENT |
| Sodium LAS | 25.0 |
| Fatty Alcohol Ethoxylate (7EO) | 0.5 |
| Fatty Alcohol Ethoxylate (3EO) | 1.5 |
| Soda Ash | 23.4 |
| Minors | balance |
| Total | 100.0 |

| | | | | | |
|---|---|---|---|---|---|
| A | B | C | D | E | F |

Varying detergent and Clay Levels (Rust Stains)

| | | | | | | |
|---|---|---|---|---|---|---|
| Composition A (g/l) | 2.5 | 2.4 | 2.3 | 2.1 | 1.7 | 1.5 |
| Clay Conc. (g/l) | 0.0 | 0.1 | 0.2 | 0.4 | 0.8 | 1.0 |
| Gelwhite (bentonite) | 8.75 | 13.17 | 15.47 | 17.23 | 19.31 | 20.59 |
| (^{Δ}R460*) | | | | | | |
| Talc (pyrophillite) | 7.35 | 10.15 | 10.08 | 10.47 | 13.17 | 13.55 |
| (^{Δ}R460*) | | | | | | |
| Virgo (^{Δ}R460*) | 9.51 | 12.09 | 12.65 | 13.68 | 12.95 | 14.33 |

Constant detergent and Varying Clay Levels (Rust Stains)

| | | | | | | |
|---|---|---|---|---|---|---|
| Compostion A (g/l) | 2.5 | 2.5 | 2.5 | 2.5 | 2.5 | 2.5 |
| Clay Conc. (g/l) | 0.0 | 0.1 | 0.2 | 0.4 | 0.8 | 1.0 |
| Gelwhite GP | 14.22 | 15.24 | 17.51 | 21.54 | 21.03 | 23.80 |
| (bentonite) (^{Δ}R460*) | | | | | | |

2. Detergency v Clay Type

Composition A (2.5 g/l) & Clay (0.5 g/l) (Rust Stains)

| | ^{Δ}R460 |
|---|---|
| | * |
| Control | 20.59 |
| Gelwhite GP (bentonite) | 24.19 |
| Laundrosil Ex0242 (bentonite) | 23.94 |
| Polargel HV (bentonite0 | 24.78 |
| Laponite RDS (hectorite) | 24.93 |
| Speswhite SPS (kaolinite) | 21.75 |
| Talc (pyrophillite) | 22.49 |
| Virgo (kaolinite) | 22.08 |
| | DE |
| Control | 16.80 |
| Gelwhite GP (bentonite) | 23.81 |
| ASP 170 (kaolinite) | 17.13 |
| Attagel 40 (attapulgite) | 20.99 |
| Supragloss 40 (kaolinite) | 17.30 |
| | ^{Δ}R460 |
| Control | 17.96 |
| Laundrosil Ex0242 (bentonite) | 20.91 |
| Laundrosil DGA (bentonite) | 21.18 |
| Polargel HV (bentonite) | 22.61 |
| Laponite RDS (hectorite) | 25.42 |

3. Detergency v Stain Type

Composition A (2.5 g/l) & Gelwhite (0.5 g/l) (Rust Stains)

| Stain Type | Bandy Black Clay | Mud | Red Clay | Coal |
|---|---|---|---|---|
| Gelwhite (bentonite) | 48.56 | 36.47 | 43.15 | 52.82 |
| (⁶⁶R460*) | | | | |
| Control | 45.54 | 30.53 | 36.57 | 49.61 |
| (⁶⁶R460*) | | | | |

Claims:

1. Use of a light coloured crystalline clay mineral to assist removal of soil from textile fabrics.

2. A method of removing soil from textile fabrics by contacting said fabrics with a light coloured crystalline clay material prior to soiling and subsequently washing said fabrics.

3. Use according to claim 1 or a method according to claim 2, wherein the light coloured crystalline clay mineral is incorporated as a component in a laundry wash composition and/or a laundry rinse composition for application to the fabrics by dispersion or dissolution in a wash and/or rinse liquor.

4. Use or method according to claim 3, wherein the composition is a washing composition and, further comprises one or more deterging surfactant and optionally also, one or more detergency builders.

5. Use or method according to claim 3, wherein the composition is a fabric rinse conditioner composition and comprises one or more cationic fabric softeners.

6. Use or method according to any of claims 3-5, wherein the composition further comprises a benefit agent selected from fluorescers, perfumes, starch, lipases, oil release polymers, photobleaches and blueing agents.

7. Use or method according to any of claims 3-6, wherein the composition further comprises a water-soluble salt.

8. Use or method according to claim 7, wherein the water-soluble salt is present at a molar concentration of from 0.001 M to 1 M.

9. Use or method according to any of claims 3-8, wherein the composition contains from 2 to 98% (for a rinse composition ) or from 0.5% to 75% (if a wash composition) by weight of the total composition.

10. Use or method according to any preceding claim, wherein the light coloured crystalline clay material is selected from one or more clays selected from bi-layer clays, e.g. china clay and halloysite, dioctahedral clays such as kaolinite, trioctahedral clays such as antigorite and amesite, smectite and hormite clays such as bentonite (montmorillonite), beidelite, nontronite, hectorite, attapulgite, pimelite, mica, muscovite and vermiculite clays, as well as pyrophyllite/talc, willemseite and minnesotaite clays.

11. Use or method according to any preceding claim, wherein the light coloured crystalline clay mixed has a reflectance of at least 60, preferably at least 70, more preferably at least 80 at a wavelength of 460 nm.

12. Use or method according to any preceding claim, wherein the number average particle size of the light coloured crystalline clay mineral does not exceed 2 μm, preferably not exceeding 1 μm.

13. Use or method according to any preceding claim, wherein the laundering is carried out by hand.

14. Use or method according to claim 13, wherein said light coloured crystalline mineral is applied to the fabrics in the form of a bar comprising said light coloured crystalline clay mineral and preferably also comprising a non-soap detergent.

15. A laundry wash bar comprising a light coloured crystalline clay mineral and preferably also comprising a non-soap detergent.
